(19) United States
(12) Patent Application Publication
(10) Pub. No.: US 2019/0166309 A1
(43) Pub. Date: May 30, 2019

(54) PANORAMIC CAMERA AND IMAGE PROCESSING METHOD

(71) Applicant: HON HAI PRECISION INDUSTRY CO., LTD., New Taipei (TW)

(72) Inventors: CHI-HSUN HO, New Taipei (TW); HSUEH-WEN LEE, New Taipei (TW); HUI-WEN WANG, New Taipei (TW); YI-TE HSIN, New Taipei (TW); CHUN-YEN KUO, New Taipei (TW)

(21) Appl. No.: 15/836,939

(22) Filed: Dec. 11, 2017

(30) Foreign Application Priority Data
Nov. 24, 2017 (TW) 106141068

(51) Int. Cl. H04N 5/232; H04N 5/225; H04N 5/272

(52) U.S. Cl. CPC H04N 5/23238; H04N 5/2252; H04N 5/2254; H04N 5/272; H04N 5/23203; H04N 5/23216; H04N 5/2258

(57) ABSTRACT

An image processing method applied to a panoramic camera includes a camera casing, at least two first lenses mounted to the casing, a second lens mounted to the casing, and at least one processor received in the casing. The processor obtains a first image captured by several first lenses and a second image captured by a single second lens. The first images are seamed together to form a panoramic image, and the second image is placed on the panoramic image to form a combined image. A size of the second image is less than a size of the panoramic image, and the position of the second image on the panoramic image can be dynamically altered to indicate the standpoint and field of view of the viewer from a particular vantage point.

### FIELD

The subject matter relates to cameras, and more particularly, to a panoramic camera and an image processing method.

### BACKGROUND

Panoramic cameras provide 360 degree views, making them suitable for overview applications in retail presentations, garage forecourt, public space, residential, and reception areas. However, the panoramic camera seaming the image from each lens to form a panoramic image lacks diversity and fails to improve the user's experience. Improvements in the art are preferred.

### BRIEF DESCRIPTION OF THE DRAWINGS

Implementations of the present technology will now be described, by way of example only, with reference to the attached figures.

FIG. 1 is a diagram of an exemplary embodiment of a panoramic camera of the present disclosure.

FIG. 2 is a block diagram of the panoramic camera of FIG. 1.

FIG. 3 is a diagram showing a plurality of first images seamed by the panoramic camera of FIG. 1 to form a panoramic image.

FIG. 4 is a diagram showing a second image superimposed on the panoramic image of FIG. 3 to form a combined image.

FIG. 5 is a flowchart of an exemplary embodiment of an image processing method.

FIG. 6 is a sub-flowchart of the block 53 of the image processing method of FIG. 5.

FIG. 7 is a diagram showing a second image superimposed on a fixed location of a visual field within the panoramic image.

FIG. 8 is a diagram showing a second image superimposed on a fixed location of the panoramic image.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

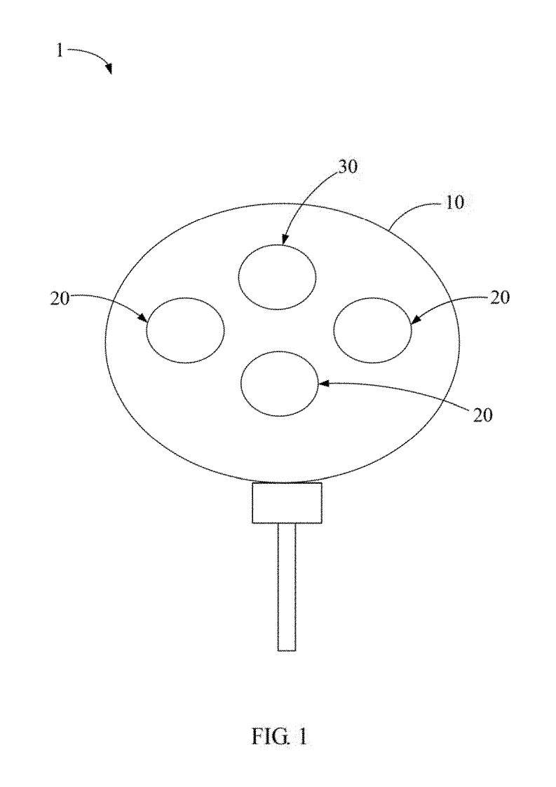

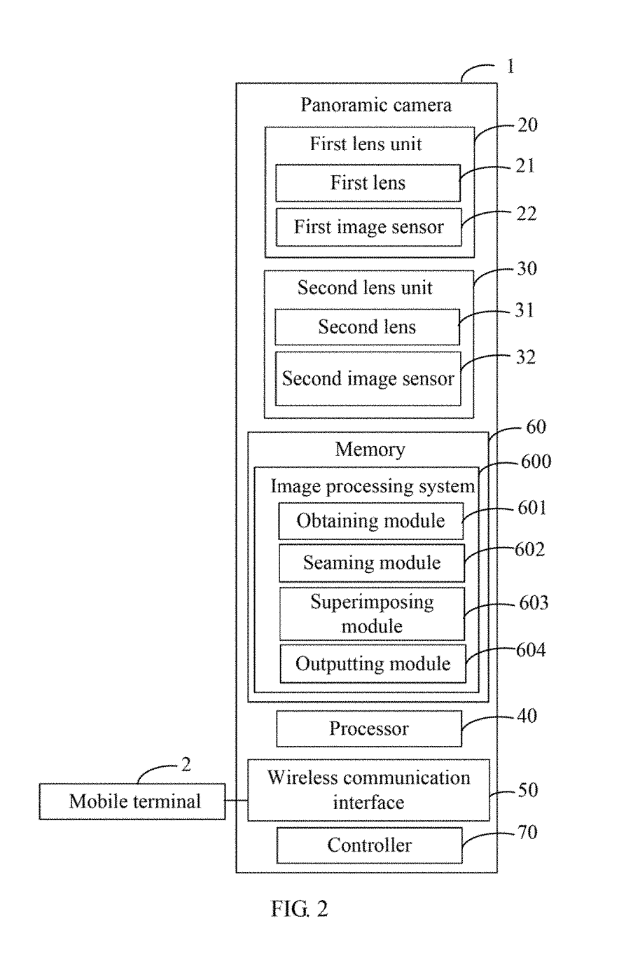

FIGS. 1 and 2 illustrate an exemplary embodiment of a panoramic camera 1. The panoramic camera 1 comprises a casing 10, and at least two first lens units 20 mounted to the casing 10, and a second lens unit 30 mounted to the casing 10.

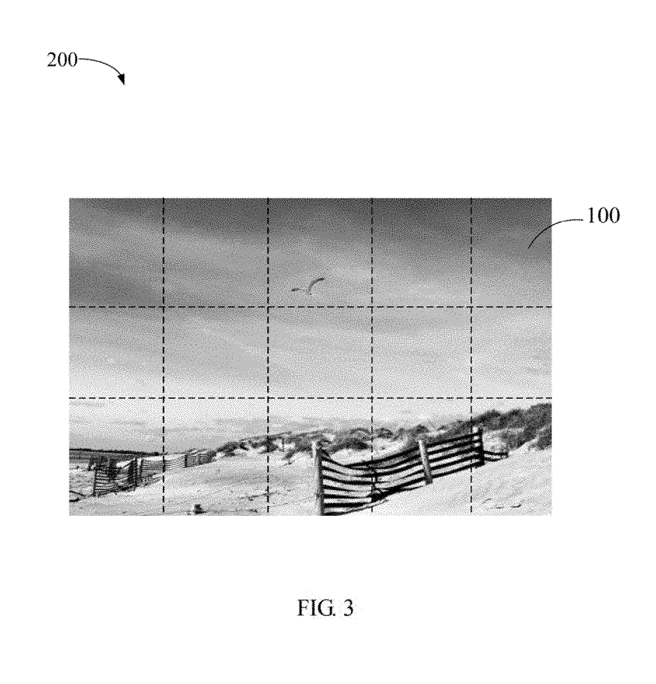

Each first lens unit 20 comprises a first lens 21 and a first image sensor 22 positioned behind the first lens 21. Each first lens 21 has a different field of view (FOV), thereby enabling the panoramic camera 1 to cover an FOV of 360 degrees or 720 degrees. Each first lens 21 collects light from objects in its FOV. Each first image sensor 22 receives the collected light from the first lens 21 to form a first image 100 (shown in FIG. 3).

In at least one exemplary embodiment, the first lens units 20 are positioned at the top, the bottom, the left, the right, the front, and the back of the casing 10 (FIG. 1 only shows three first lens units 20 at the front of the casing 10).

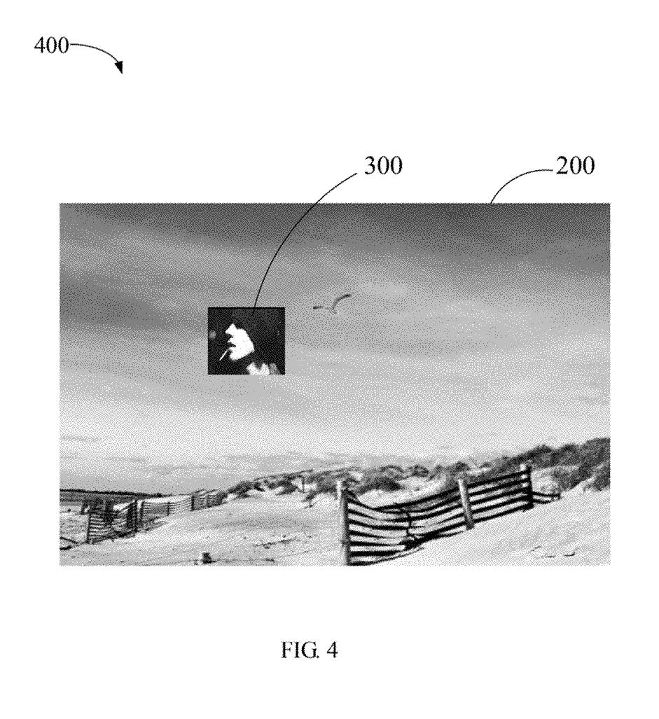

The second lens unit 30 comprises a second lens 31 and a second image sensor 32 positioned behind the second lens 31. Each second lens 31 collects light from objects in its FOV. Each second image sensor 32 receives the collected light from the second lens 31 to form a second image 300 (shown in FIG. 4).

One or more processors 40 and a memory 60 are positioned in the casing 10. The memory 60 stores an image processing system 600. The image processing system 600 comprises an obtaining module 601, an seaming module 602, a superimposing module 603, and an outputting module 604. The modules 601-604 may comprise computerized instructions in the form of one or more programs that are stored in the memory 60 and executed by the at least one processor 40.

The obtaining module 601 is electrically connected to each first image sensor 22 and the second image sensor 32. Referring to FIGS. 3 and 4, the obtaining module 601 obtains the first image 100 from each first image sensor 22, and obtains the second image 300 from the second image sensor 32.

The seaming module 602 seams the first images 100 to form a panoramic image 200.

The superimposing module 603 superimposes the second image 300 on the panoramic image 200 to form a combined image 400. The size of the second image 300 is less than the size of the panoramic image 200.

The outputting module 604 outputs the combined image 400 to a peripheral device (such as a display device, not shown).

In operation, the second lens 31 may be controlled to face an area in which the user is interested. Then, the second lens 31 can function as a main lens to capture a main image (that is, the second image 300). Each first lens 21 can function as an auxiliary lens to capture background image (that is, the first image 100). The main image is not seamed with the background image, instead, the main image is superimposed on the background image to emphasize the main image from the view of the user.

Before forming the combined image 400, the seaming module 602 can further adjust the size of the second image 300, and/or the location of the second image 300 relative to the panoramic image 200.

The panoramic camera 1 can be controlled to enter a remote mode. When the panoramic camera 1 is in the remote mode, the panoramic camera 1 can receive remote commands from a mobile terminal 2 and perform operations accordingly. The mobile terminal 2 can be a remote control, a smart phone, or a tablet computer.

Furthermore, a wireless communication interface 50 is mounted to the casing 10. The wireless communication interface 40 receives the remote commands from the mobile terminal 2. A controller 70 is positioned in the casing 10. The controller 70 is electrically connected to the wireless communication interface 50. The controller 70 obtains the remote commands from the wireless communication interface 50, analyzes the remote commands, and controls the panoramic camera 1 to perform the operations accordingly.

In at least one exemplary embodiment, the remote commands comprise, but are not limited to, a first remote command for controlling the casing 10 to rotate, a second remote command for controlling the second lens 31 to adjust focal length, and a third remote command for controlling the second lens 31 to turn on or turn off.

The controller 70 controls the casing 10 to rotate in response to the first remote command, to change the field of view of the second lens 31. The controller further controls the second lens 31 to adjust the focal length in response to the second remote command, to improve the resolution of the second image 300. The controller 70 further controls the second lens 31 to turn on or turn off in response to the third remote command.

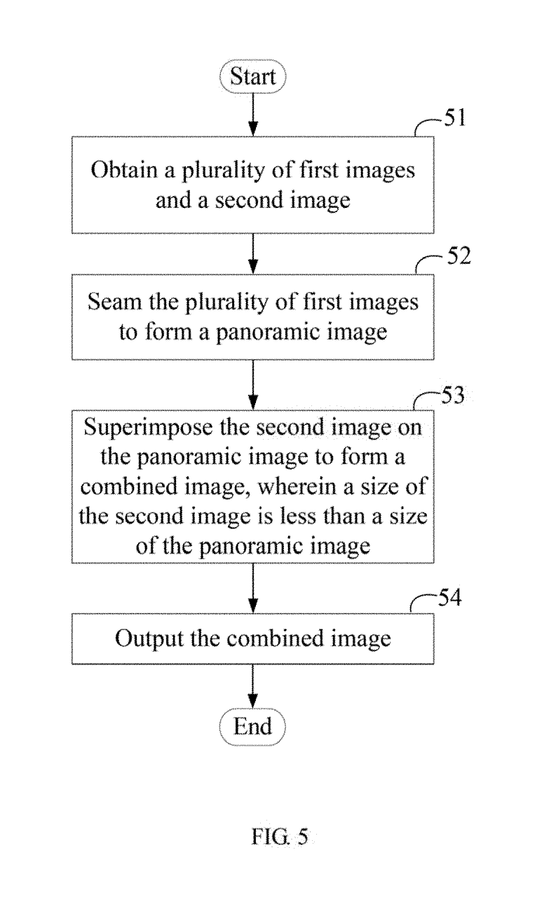

FIG. 5 illustrates an exemplary embodiment of an image processing method. The method is provided by way of example, as there are a variety of ways to carry out the method. The method described below can be carried out by the panoramic camera 1 using the configurations illustrated in FIGS. 1-4, for example, and various elements of these figures are referenced in explaining example method. However, the method can also be carried out by any display device which needs to obtain images and process the obtained images. For example, the method can be carried out by a visual reality (VR) head-mounted display device. Each block shown in FIG. 5 represents one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 501.

At block 51, the obtaining module 601 obtains a plurality of first images 100 and a second image 300.

At block 52, the seaming module 602 seams the first images 100 to form a panoramic image 200.

At block 53, the superimposing module 603 superimposes the second image 300 on the panoramic image 200 to form a combined image 400. The size of the second image 300 is less than the size of the panoramic image 200.

In at least one exemplary embodiment, before forming the combined image 400, the seaming module 602 can further adjust the size of the second image 300, and/or the location of the second image 300 relative to the panoramic image 200.

In at least one exemplary embodiment, the seaming module 602 adjusts the size of the second image 300 and/or the location of the second image 300 according to a preset rule. For example, the preset rule may be that a ratio of the size of the second image 300 after adjustment with respect to the size of the panoramic image 200 is about 1:4. The preset rule may also be that the second image 300 after adjustment is located at the top left corner of the panoramic image 200.

In another exemplary embodiment, when the image processing method is carried out by the VR head-mounted display device, the user can perform a preset gesture or press a button of the VR head-mounted display device, to control the seaming module 602 to adjust the size of the second image 300 and/or the location of the second image 300 relative to the panoramic image 200.

At block 54, the outputting module 604 outputs the combined image 400.

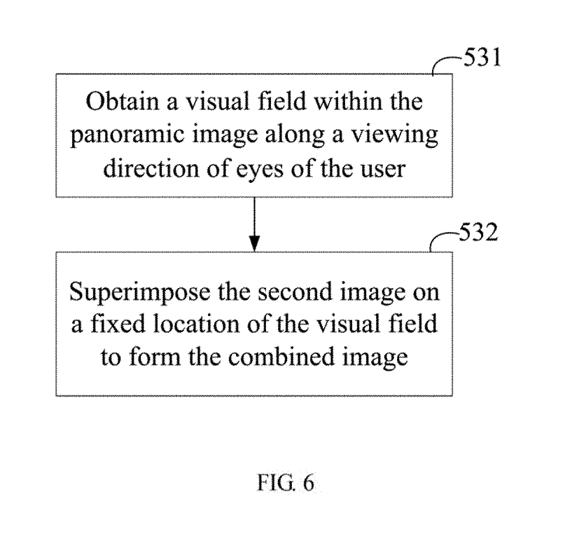

FIG. 6 illustrates a detail flowchart of the block 53 of the image processing method of FIG. 5, when the image processing method is carried out by the VR head-mounted display device. The example method can begin at block 531.

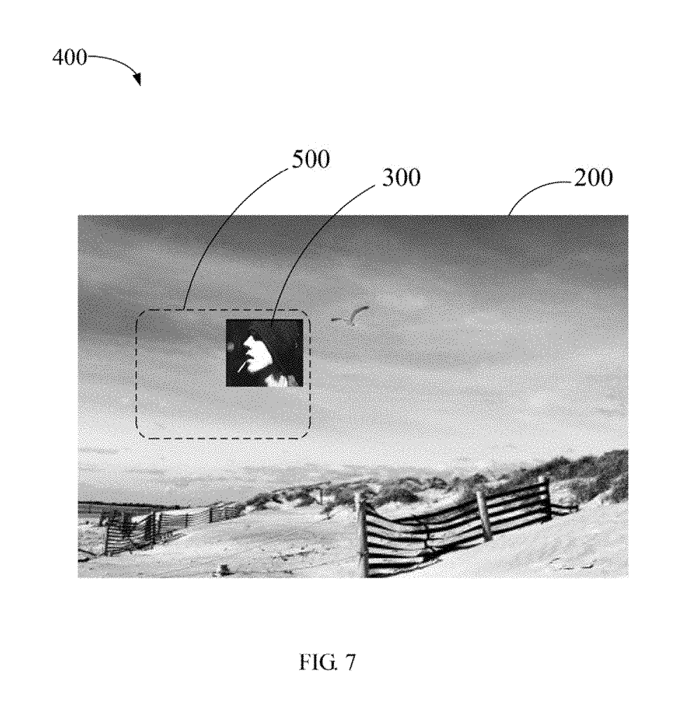

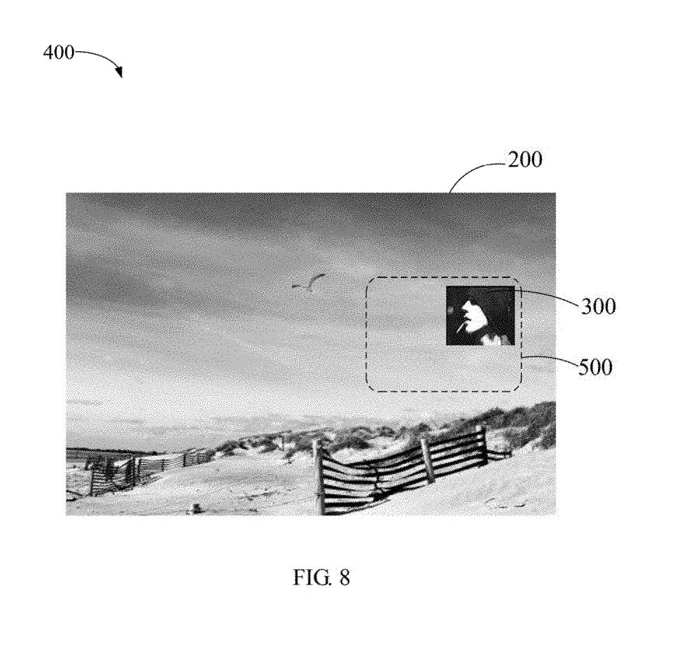

At block 531, referring to FIGS. 7 and 8, the superimposing module 603 obtains a visual field 500 within the panoramic image 200 along a viewing direction of eyes of the user.

In at least one exemplary embodiment, the VR head-mounted display device comprises an eye tracker, which can detect the visual field 500 within the panoramic image 200 along the viewing direction of eyes of the user. The superimposing module 603 obtains the visual field 500 within the panoramic image 200 from the eye tracker.

At block 532, the superimposing module 603 superimposes the second image 300 on a fixed location of the visual field 500 to form the combined image 400.

Thus, when the viewing direction of the user is changed (for example, when the user turns his head) to cause the visual field 500 to move from the left portion to the right portion of the panoramic image 200, since the superimposing module 603 superimposes the second image 300 on the fixed location of the visual field 500, the second image 300 can move together with the visual field 500. That is, the second image 300 appears on the fixed location of the visual field 500.

In another exemplary embodiment, the superimposing module 603 can also superimpose the second image 300 on a fixed location of the panoramic image 200. Thus, the second image 300 does not move with the visual field 500. That is, the second image 300 appears on the fixed location of the panoramic image 200.

With the above configuration, the second image 300 is not seamed with the first images 100, instead the second image 300 is superimposed on the panoramic image 200 to emphasize the second image 300 from the view of the user. The image processing method is different from the existing panoramic image processing method, and can improve the user's experience.

Depending on the embodiment, certain of the steps of method hereinbefore described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. A panoramic camera comprising:
a casing;
at least two first lenses mounted to the casing;
a second lens mounted to the casing; and
at least one processor received in the casing, the processor configured to obtain a first image captured by each first lens and a second image captured by the second lens, seam the first images to form a panoramic image, and superimpose the second image on the panoramic image to form a combined image, wherein a size of the second image is less than a size of the panoramic image.

2. The panoramic camera of claim 1, wherein before forming the combined image, the processor is further configured to adjust the size of the second image, and a location of the second image relative to the panoramic image.

3. The stereoscopic video device of claim 1, further comprising a wireless communication interface and a controller, wherein the wireless communication interface is configured to receive remote commands from a mobile terminal, the controller is electrically connected to the wireless communication interface, the controller is configured to obtain the remote commands from the wireless communication interface, analyze the remote commands, and control the panoramic camera to perform operations accordingly.

4. The panoramic camera of claim 3, wherein the remote commands comprise a first remote command for controlling the casing to rotate, and the controller is further configured to control the casing to rotate in response to the first remote command, to change a field of view of the second lens.

5. The panoramic camera of claim 3, wherein the remote commands comprise a second remote command for controlling the second lens to adjust focal length, and the controller is further configured to control the second lens to adjust the focal length in response to the second remote command.

6. The panoramic camera of claim 3, wherein the remote commands comprise a third remote command for controlling the second lens to turn on or turn off, and the controller is further configured to control the second lens to turn on or turn off in response to the third remote command.

7. An image processing method comprising:
obtaining a plurality of first images and a second image;
seaming the plurality of first images to form a panoramic image; and
superimposing the second image on the panoramic image to form a combined image, wherein a size of the second image is less than a size of the panoramic image.

8. The image processing method of claim 7, further comprising:
outputting the combined image.

9. The image processing method of claim 7, wherein before forming the form combined image, the image processing method further comprises:
adjusting the size of the second image, and a location of the second image relative to the panoramic image.

10. The image processing method of claim 7, wherein the step of superimposing the second image on the panoramic image to form a combined image further comprises:
obtaining a visual field within the panoramic image along a viewing direction of eyes of a user; and
superimposing the second image on a fixed location of the visual field to form the combined image, thereby causing the second image to move together with the visual field.

11. The image processing method of claim 7, wherein the step of superimposing the second image on the panoramic image to form a combined image further comprises:
obtaining a visual field within the panoramic image along a viewing direction of eyes of a user; and
superimposing the second image on a fixed location of the panoramic image to form the combined image, thereby preventing the second image from moving together with the visual field.
